(19) United States
(12) Patent Application Publication
(10) Pub. No.: US 2008/0262932 A1
(43) Pub. Date: Oct. 23, 2008

(54) Resturant and bar consumer display

(76) Inventor: Andrew Wareham, Chicago, IL (US)

Correspondence Address: THE ECLIPSE GROUP LLP, 10605 BALBOA BLVD., SUITE 300, GRANADA HILLS, CA, 91344, US

(21) Appl. No.: 12/148,474

(22) Filed: Apr. 18, 2008

Related U.S. Application Data
(60) Provisional application No. 60/925,411, filed on Apr. 20, 2007.

(51) Int. Cl. G06Q 30/00; G06F 3/14

(52) U.S. Cl. 705/14

(57) ABSTRACT

A restaurant and bar consumer display that consists of an active matrix OLED display, memory, microprocessor board, tilt sensor, USB port, battery, enclosed in a case that may be a coaster and attachable to a container, such as a glass or jar or implemented as a standup placard.

### 1. RELATED APPLICATIONS

This application claims priority and incorporates by reference the provisional patent application Ser. No. 60/925,411, filed on Apr. 20, 2007, titled “RESTAURANT AND BAR SONSUMER DISPLAY” by Andrew Wareham, which is incorporated by reference herein.

### 2. BACKGROUND

Advertising in restaurants and bars is limited and often annoyingly intrusive with advertisers unable to target local and national audiences in a non-intrusive manner. Typically, every customer in a restaurant or bar has a glass of liquid to drink and sits at a table or bar. Often, these liquids are clear or semi-clear, enabling a person to see the bottom of the glass. The bottom of the glass is a prime place for placement of a message.

Similarly, a person sitting at a table or bar often sees placards that advertise specials or provide other relevant information. The information in the placards must be changed manually but cannot quickly be changed on a table in the dinning room and bar. Thus, there is a need to be able to provide table and bar information in a fashion that can be quickly updated or changed easily.

Current approaches to using this advertising space have been limited to writing on the bottom of the glass or paper mounted on the placard. These approaches limit the ability to change the message or give real-time information, such as food/drink specials, news, and sensor information. Further, entertaining people while they are awaiting service is typically lacking at restaurants and bars. If entertainment is available at the table it is often only word games or wooden puzzles.

Therefore, there is a need for an approach that can easily update or change the information and/or advertising that may be placed at a table or at the bottom of a glass or other container, and provide entertainment at the table.

### SUMMARY

The restaurant and bar consumer display may be called a Coastii. The Coastii's ability for pictures, video, games, internet, and all around connectivity poise it to open up a completely new way to advertise. The Coastii will let advertisers get into the home market by sponsoring services such as weather data, sport scores, services, and placing ads in games to market to kids. User data may be provided for this market as well. The second market is the restaurant pager market. The Coastii enables companies to advertise to people in restaurants or bars effectively and change those ads in real time. The Coastii provides complete statistical tracking of end users, while providing entertainment and unobtrusive advertising. The Coastii is a sleek portal to the world for end users, and a new way to advertise in two untapped markets.

The restaurant and bar consumer display may be made encased in a watertight seal of polypropylene, and be equipped with an OLED display, circuitry, battery, and input/output port. To access the battery and input/output ports, a custom unscrewing attachment may have to be used to access the bay on the underside of the display coaster. This bay is covered by a screw-down piece of rubber/Polypropylene that goes over the sealed bay. Inside, there may be one or more input/output ports and a removable battery. The graphics system may include a microprocessor board, tilt sensor, and the OLED display that may display a digital image. The display may be mounted in a table or bar placard or in a display coaster. The tilt sensor in the display coaster may display another digital image and a brighter digital image at different degrees of tilt. Examples of the digital image formats that may be supported include jpg, and gif and example video format may include avi, mpeg, or similar digital video format.

Tilt sensors may also be placed in the display coaster and enable it to control electronic games being displayed on the display coaster, such as the old marble madness video game.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a top view 100 of a display coaster 102 having an OLED display 104.

FIG. 2 is a side view 200 of the display coaster 102 of FIG. 1.

FIG. 3 is a bottom view 300 of the display coaster 102 of FIG. 1.

FIG. 4 is a side-view 400 of a portion of the microprocessor board 202.

FIG. 5 is a side cut-away view 500 of a table or bar placard implemented with the microprocessor board 202 of display coaster 102.

FIG. 6 is a front cut-away view 600 of a table or bar placard implemented with the microprocessor board 202 of display coaster 102.

FIG. 7 is a flow diagram 700 of the operation of the display coaster 102 is shown.

FIG. 8 is a diagram 800 of a holder 802 for the display coaster 102 of FIG. 1.

FIG. 9 is a diagram 900 of a wall mounted holder 902 for the display coaster 102 of FIG. 1.

### DETAILED DESCRIPTION

An approach for restaurant and bar consumer display implemented in a display coaster 102 that enables still and moving digital images and designs to be displayed through a bottom of a container. In the current implementations, organic light-emitting diodes (OLEDs) may be employed. Examples of OLEDs may include active-matrix OLED (AMOLED) display on flexible metal foil that may be based on the phosphorescent OLED (PHOLED™), top-emitting OLED (TOLED®) and flexible OLED (FOLED®). An OLED is a type of light-emitting diode (LED) in which the emissive layer comprises a thin-film of certain organic compounds. The emissive electroluminescent layer may include a polymeric substance that allows the deposition of very suitable organic compounds, for example, in rows and columns on a flat carrier by using a simple “printing” method to create a matrix of pixels that emit different colored light.

A benefit of an OLED display over the traditional LCD displays is that OLEDs do not require a backlight to function. This means that the OLED draws less power and, when powered from a battery, can operate longer on the same charge. OLEDs may also be referred to as OEL or Organic Electro-Luminescence.

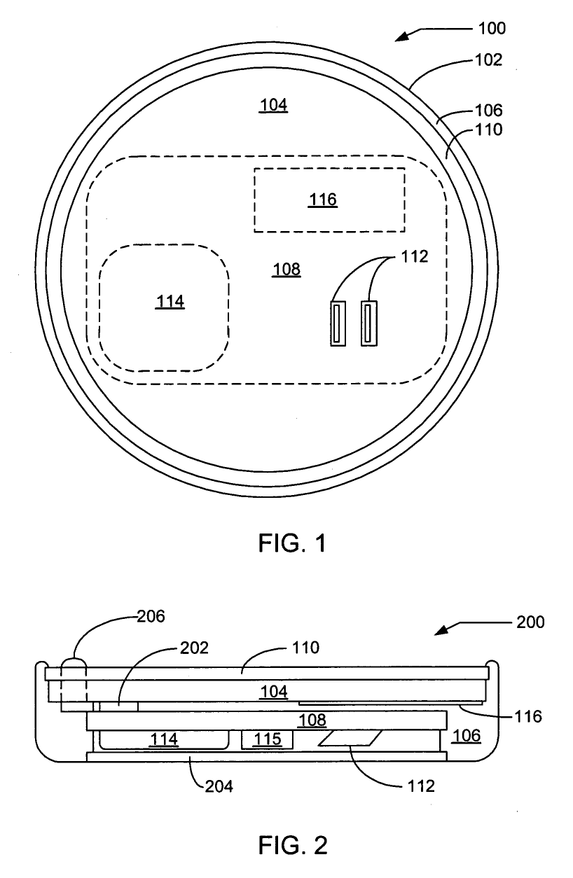

In FIG. 1, a top view 100 of a display coaster 102 having an OLED display 104 is depicted in accordance with an exemplar embodiment of the display coaster. The display coaster 102 may be round, square, or any shape that is formed in a way that can be secured to a bottom of a container. The container may be a glass, a jar, a cup, or similar such containers typically for liquid. Further, the display coaster may be round in a puck shape without the requirement of being attachable to another container. The housing 106 of the display coaster 102 may be composed of polypropylene housing. In other implementations, the housing 106 may be made out of such other materials as plastic, ceramic, wood, or any other material that may house the OLED display 104 and associated microprocessor board 108. In other implementations, other displays may be employed, such as liquid Crystal Display, digital paper, 2D holographic projection, 3D holographic projection to give but a few examples.

The microprocessor board 108 is one or more circuit boards that have one or more semiconductor chips that function as a microprocessor and display controller. An example of a microprocessor board 108 is a circuit board from a personal digital assistant, such as a palm pilot or hand held computer. Such a microprocessor board may run an embedded operating system, Windows CE™, Linux.

The polypropylene housing 106 may secure the OLED display 104. The OLED display 104 may also be mounted on a microprocessor board 108. A clear cover 110 may be placed over the OLED display 104 and supported by the housing 106. The clear cover 110 may be coated with a material to reduce or prevent fogging, such as a DuPont substance known as Zonyl FSN-100. The microprocessor board 108 may also have an interface such as one or more universal serial bus (USB) connections 112 and battery 114. A radio frequency identification tag (RFID) 116 may be located within the housing, such that external digital content may be triggered by and sent to the display coaster 102 in response to the detection of the RFID tag 116.

In other implementations, other types of connections such as wireless connections (Wi-Fi, Zigbee, wireless USB, simple RF, or Blue Tooth) may be employed such that digital communications may occur between the actual processors that may be present on the microprocessor board 108 and a downloading device. It is also possible that a USB memory device may be configured with the digital content and downloaded to memory located on the microprocessor board 108 to program the digital content of the display coaster 102. The programming of the display coaster 102 may be accomplished in other implementations using a parallel port or an IEEE 1394 port. In addition to digital media, the memory on the microprocessor board 108 may be used to store one or more statistics, such as number of glass tilts, number of glass tilts per hour, temperate, amount of “on” time, power remaining, acceleration, and identification number, for examples.

The memory used with the microprocessor board 108 may be individual SDRAM chips, memory modules like DDR, DDR2, SDRAM, or other types of solid state memory. In other implementations, additional memory devices, such as flash memory chips, solid state hard drives, programmable read-only memory (PROMs), electronically erasable programmable read-only memory (EEPROMs) may be connected to the microprocessor board 108.

Turning to FIG. 2, a side view 200 of the display coaster 102 is depicted in accordance with an exemplar embodiment of the display coaster 102. The poly propylene housing 106 may surround the OLED display 104 in the current embodiment. In other implementations, the OLED display 104 may be secured by adhesive, screws, or spring brackets. The clear cover 110 may be a clear acrylic lens. The clear cover 110 may also be secured via the polypropylene housing 106. In other implementations, the Clear cover 110 may be secured using alternative methods such as adhesive, springs, screws, or other types of devices that can securely attach the clear acrylic lens over the OLED display 104. In yet other implementations, it is also possible for the OLED display 104 to actually be secured by the clear acrylic lens 202 with the OLED display 104 sitting in a groove or other tight pocket and secured only by the clear acrylic lens 202. In the current implementation the microprocessor board is under the OLED display 104.

The OLED display 108 may be in direct contact with the microprocessor board 108, or in other implementations, may be connected to the microprocessor board 108 via bus wires 202. The microprocessor board 108 may also have contacts for a battery 114. The battery 114 may be nickel cadmium, lithium, hydrogen fuel cell, micro-fuel cell or other some other type of known dry cell power supply. The battery 114 may be recharged via USB port 112 and a cover 204 may be placed over the battery 114 and USB port 112. The cover 204 may be placed over the battery 114 and USB port 112 and secured to make water tight seal between the cover 204 and the polypropylene housing 106 by screws, fasteners or tabs.

The microprocessor board 108 may also have a tilt sensor 115 that communicates with the microprocessor. The tilt sensor 115 is shown as being on the microprocessor board 108, but in other implementations the tilt sensor may be located at other places within the display coaster 102. The tilt sensor may be a mechanical switch with a conductive liquid that moves among different contacts within the tilt sensor. Once type of conductive liquid is the element mercury.

The tilt sensor 115, or other types of motion sensing devices (i.e. gyroscopes, accelerometer, GPS receivers) may be used for motion control to send signals to the microprocessor located on the microprocessor board 108. The motion control may be used to control the graphics being displayed on the OLED display 104. An example of such control may be a game played on the display coaster 102, such as marble madness video game, where the tilting of the display results in an action in the game. In this example, the reaction is the movement of the digital marble in the digit field that appears in the OLED display 104.

Other types of sensors may be used in addition to motion sensors. Examples of such sensors include thermometers, capacitance, pressure sensors, moisture sensors, light sensors, and image capturing devices 206 (i.e. video cameras and digital image cameras). The image capturing device 206 may be coupled to the processor board 108 and may communicate with the controller and memory.

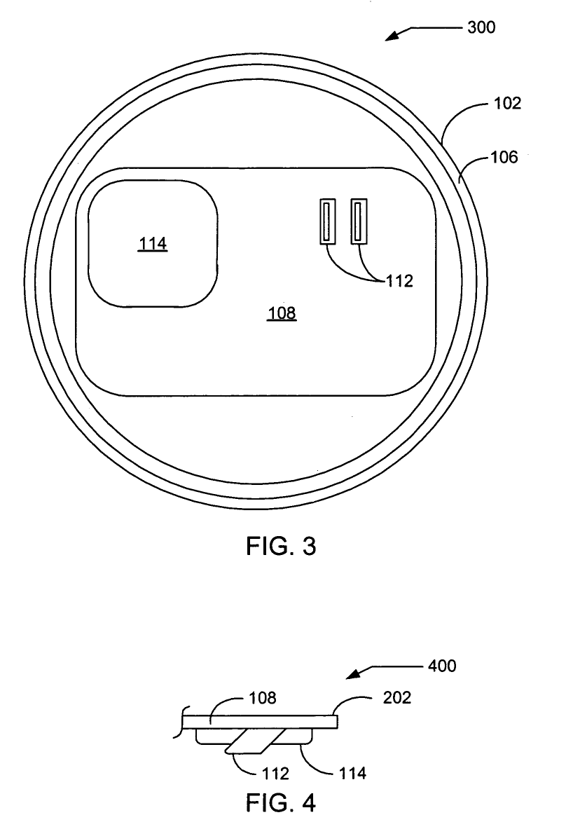

In FIG. 3, a bottom view 300 of the display coaster 102 is depicted in accordance with an exemplar embodiment of the display coaster. The polypropylene housing 106 holds the microprocessor board 108 in place and has an open portion in the bottom that is coverable by cover 204. When the cover 204 is removed as depicted in FIG. 3, the battery 114 and USB port 112 are accessible. In other implementations, the battery and USB port 112 may be accessed from the top, sides, or bottom depending on the design of the display coaster 102. The USB port 112 may be always visible with access through the cover 204, or in yet other implementations through the polypropylene housing 106.

The ports for programming the display coaster 102 may be located on the top and bottom in such a manner that when multiple display coasters are stacked, they form a communication bus of daisy-changed devices. It is also conceivable that the display coaster 102 may have conductive pads that may be in contact with other coasters and a base station and communicate over a two or more wire bus formed by the conductive pads being in contact with conductive pads on the base stations and other display coasters. It is also foreseeable to use a conductive communication approach to program the display coaster 102 without have to actually be in contact with the display coaster 102. In other implementations, a vibrating mechanism as found in pagers and cell phones may be placed within the display coaster 102 to enable the display coaster to be used as a paging device. A visual perceptible indicator (flashing OLED screen, separate LEDs in the polypropylene housing, etc. . . . ) may also be placed in the display coaster 102 to enable a person to see when it is being paged.

The OLED display 104, having the capabilities of displaying a digital image or video may be configurable to display a portion of a panoramic image or video. Multiple display coasters may then be placed next to each other where each has a portion of the panoramic image. The image may be divided across each coaster by setting portion size to a fixed six (i.e. a quarter of the picture) and a mod four (if quarters are used) of the serial number results in what portion is displayed on each coaster. Another implementation enables all coasters to be loaded with the same picture, but a portion of the picture is cropped leaving only a desired viewing area on a coaster's OLED display 104. Each coaster that has the same picture may be cropped differently using controls located on the display coaster 102.

The OLED display 104 may also be implemented as a touch screen enabling user input to the display coaster 102. The user input may be used within the display coaster 102 or transmitted to a receiver via wireless signaling. Buttons may also be placed around the OLED display 104 in order to display definable buttons that enable users to input different types of data depending on the OLED display 104.

Without a touch screen, recessed buttons may be placed at the front bottom portion of the placard or with a touch screen every tab or icon may be touch sensitive. These buttons may include, for example, a menu button, a news button, a message button, up/down buttons, and a enter/hold button.

When pressing the menu button a virtual menu may appear with a tabbed list on what is selectable on the left side such as appetizers, salads, drinks, and the different kinds of entrées available. After selecting what category you wanted with the recessed buttons or touch screen, the complete list of items available may be displayed. Then a user may scroll through them with up and down buttons or scroll wheel. Once a selection of an item occurs, detailed information may be available such as ingredients, calories, a detailed picture of the item, the description, and a choice to order it as is or a choice to choose what ingredients to leave out.

When selecting what ingredients to leave out a user may select one or more with the up/down/scroll wheel button by pressing the enter/hold button. Once all selections are made you can select the order icon on screen with the buttons or touch screen.

When the news button is pushed it brings the news menu. The news menu has different tabs, current news from the associated press, sports scores, lottery numbers, and other news related consumer info when needed. The current news tabs brings up the top ten news stories that are fully scrollable and readable. The up and down arrows are used to scroll and the enter button is used to zoom. The sports scores tab brings a list of latest sports scores from the latest finished games, and a list of games currently ongoing that could be updated every hour until completion. The lottery numbers tab brings up all relevant lottery numbers to be selected and zoomed in for best possible viewing.

The message button may also bring up a list of prescreened and pre-selected custom messages available to send to other units to facilitate communication, dinner dating, speed dating, and other social activities. A user may select out of prescreened messages or the user can ask a waiter/waitress what table to send a custom message to and they will send your message. The restaurant and bar consumer display may have the option to turn off messages if they choose. Once the restaurant and bar consumer display has its messages turned off, another table may buy a drink for the other table but may not send messages.

The display coaster 102 may be coupled with a container. Tabs may be present in the glass that match-up with the display coaster 102, friction tabs may be used on the display coaster 102, screw with threads and groves may also be used. In yet another approach, an insulated cozy may be used along with the display coaster 102 to secure the display coaster 102 to a container.

Turning to FIG. 4, a side-view 400 of a portion of the microprocessor board 108 is depicted in accordance with an exemplar embodiment of the display coaster. The microprocessor board 108 is shown with a battery 114 and USB port 112 connected to the microprocessor board 108.

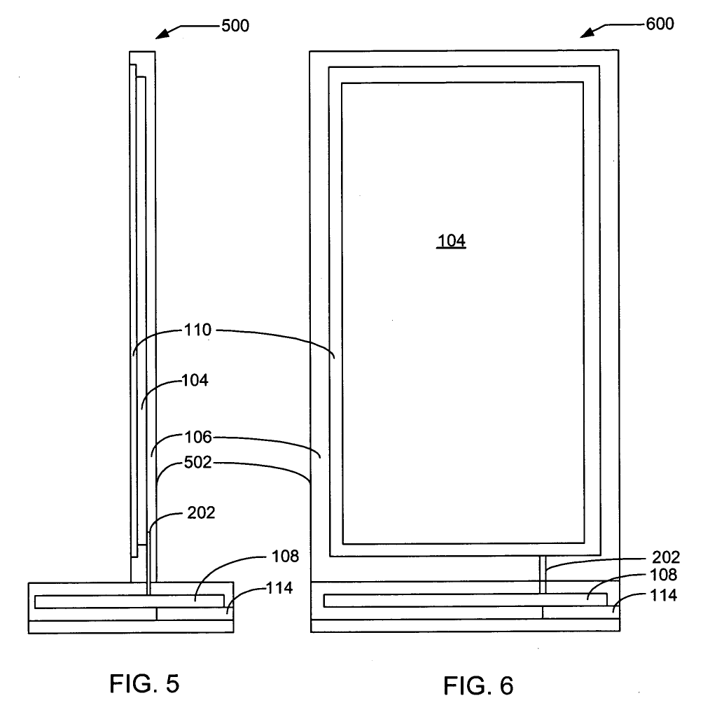

In FIG. 5, a side cut-away view 500 of a table or bar placard 502 may be implemented with the microprocessor board 108 is shown. The table or bar placard 502 may have a OLED display 104 covered by a clear cover 110 supported by a polypropylene housing 106 and connected to the microprocessor board 108 by bus 202 and receive power from battery 114. In the depicted example, only a one side display is shown. In other implementations, a two or more side implementation may be used. The microprocessor board is shown in the base of the table or bar placard 502, but in other implementations may be located in the placard portion of even in the table with a bus or other connection to the OLED display 104.

In yet other implementations, a sensor, RFID tag, RFID reader, or other signaling device may be implemented in the table or bar placard 502 (or even the display coaster 102) that identifies the location of the table or bar placard 502 within an establishment. The RFID information or other sensor may have an identifier that is associated with an entry in a database that records statistical information about a person who is using the restaurant and bar consumer display.

Turning to FIG. 6 a front cut-away view 600 of a table or bar placard 502 implemented with the microprocessor board 202 is shown. The elements shown in FIG. 6 are the same elements as discussed in FIG. 5. The issue of power control is addressed in the table or bar placard 502, by use of an internal clock that may be set to turn the placard on in the morning (when the establishment opens) and off at night (when the establishment closes). Further, in other implementations the table or bar placard 502 may have sensors for detecting motion or the handling of the table or bar placard 502 (for example, movement sensor, plunger switch, capacitance detector). The sensors may change the state of the table or bar placard 502 from a sleep state to an active or display state for a predetermined time period in order to conserve power.

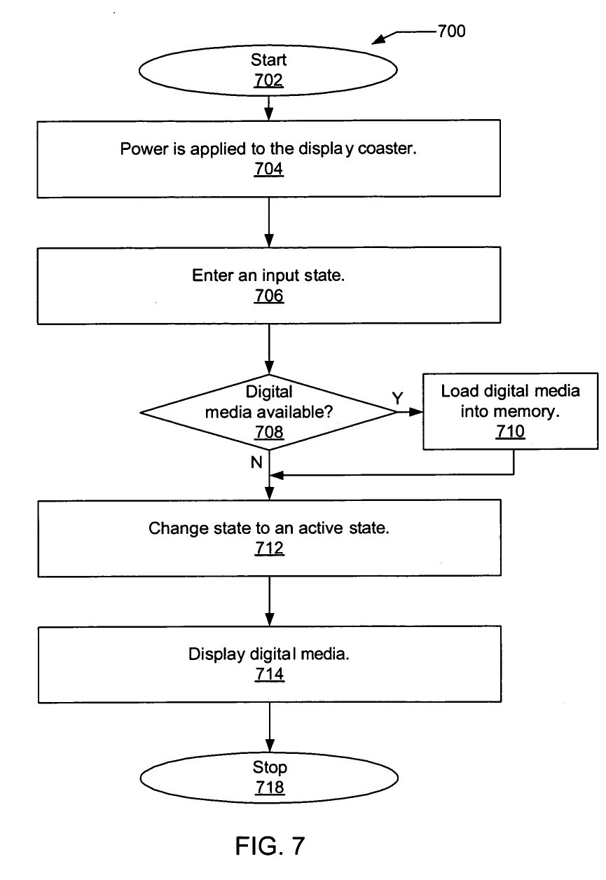

In FIG. 7, a flow diagram of the operation of the display coaster 102 is shown. The flow diagram starts 702, with power being applied to the display coaster 102 in step 704. This may be accomplished by an on/off switch or some other method of electronically signaling to the microprocessor board 108 to change states from off to on.

The display coaster 102 may be in an input state for a predetermined amount of time after initially being powered on in step 706. During the input state, a determination is made if digital media is available for loading in step 708. If the digital media is available in step 708, then it is loaded in step 710. After the loading of the digital media in step 710, the state of the display coaster 102 is changed to an active state in step 712. The digital media may be loaded in step 708 into a memory located on the microprocessor board 108 from an external source, for example USB port, flash drive, memory chip (compact flash, SD memory, micro SD memory, Memory Stick). If in step 708, there is no digital media available for loading, then the state of the display coaster is changed to an active state in step 712. In the active state, the display coaster 102 displays in step 714 the digital media that is stored in memory accessed by the microprocessor on the microprocessor board 108. The flow is shown as stopping in step 716, but in practice, the displaying of digital media may continue. In other implementations, predetermined events may change the state of the coaster or the digital media being displayed. In addition to changing the digital media, only a portion of the digital media may be changed, such when time is being displayed and updated by a clock.

The digital media may also be executed by the microprocessor on the microprocessor board 108 as a menu or tree of selectable media. A user would use inputs located on the restaurant and bar consumer display to traverse the menu of selectable media. An example of this type of implementation would be a menu on where a customer selects drinks, appetizers, or entrées. Depending on the selection, a listing of drinks, appetizers, or entrees appears. The person than can select an item and get more information about portions, health information, or even other items that may complement the selection. Further, if a transmitter is present in the restaurant and bar consumer display, the selections may be transmitted to the kitchen, bar or waitperson workstation.

In other implementations, sensors may be included on the microprocessor board 108 to determine ambient light, acceleration of the glass, temperature of a glass setting on coaster, temperature of room, movement of the display coaster 102, to give but a few examples. Further, a clock may be present to track time that may be displayed by the OLED display 104 or in a separate display. The brightness of the OLED display 104 may be adjusted in response to one or more sensors or additional information, such as temperature may be displayed on the OLED display. The clocks and sensors may be implemented to trigger predetermined events that change the digital media displayed on the OLED display 104.

In some implementations, an infra-red sensor may be use in a restaurant and bar consumer display to enable remote control of the digital media. An example of this would be a bartender sending an infra-red signal to a restaurant and bar consumer display and the display generating a message that the person has received 10% off their bill. In other implementation, another type of signal, such as radio frequency (RF) signal, audio signal, or similar signal may be employed in the restaurant and bar consumer display.

In order for the people who are blind or sight-impaired to use the restaurant and bar consumer display, a speaker may be in signal communication with the microprocessor board 108 and convert text to speech using known text to speech routines, or play sounds (music and dialog) along with the digital media (may also be contained in the digital media).

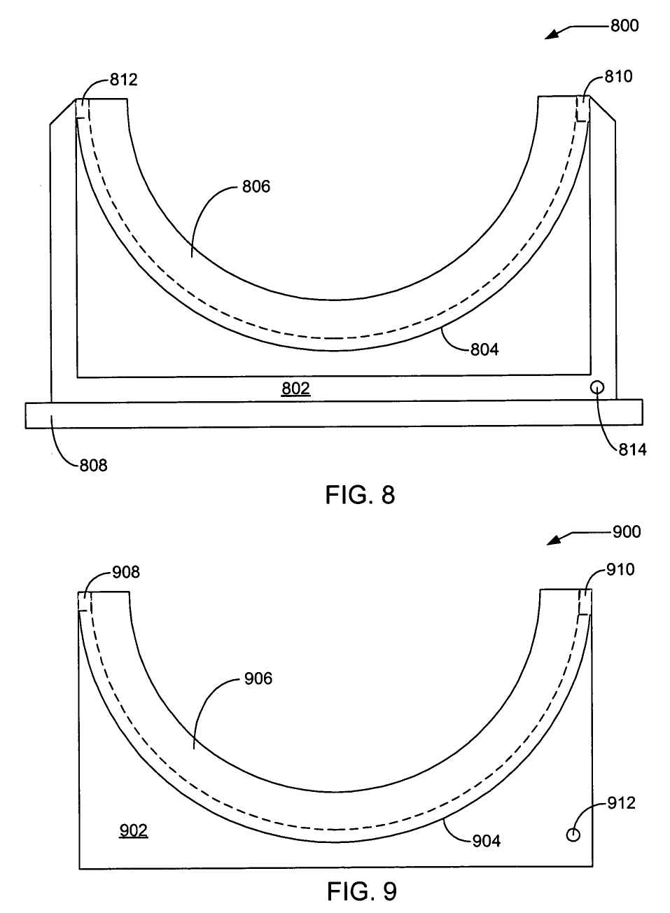

Turning to FIG. 8, diagram 800 of a holder 802 for the display coaster 102 of FIG. 1 is depicted. The holder 802 is shaped to accept a display coaster 102 and hold it in the upright position, so the OLED display 104 is viewable. The support member 804 may have a channel or grove 806 in which the display coaster 102 rest. The support member may be further supported by a base 808. While a display coaster 102 is in a holder 802, it may make contact with electrical contacts 810 and 812. Electrical contracts 810 and 812 may be electrical pads used to recharge the battery of the display coaster 102. An electrical adaptor may be used to convert AC voltage to DC voltage in the range of 3-12 volts, with 6 volts being a preferred voltage. The electrical adaptor may plug into the holder 802 at receptacle 814. In other implementations, batteries may be use instead of the electrical adaptor. In yet other implementations, the holder 802 may not contain any electronics and only function to hold the display coaster 102 upright.

In FIG. 9, a diagram 900 of a wall mounted holder 902 for the display coaster 102 of FIG. 1 is depicted. The wall mount holder 902 may have a support 904 with a channel or grove 906 that accepts the display coaster 102 and supports it in an upright manner. While a display coaster 102 is in the wall mount holder 902, it may make contact with electrical contacts 908 and 910. Electrical contracts 908 and 910 may be electrical pads used to recharge the battery of the display coaster 102. An electrical adaptor may be used to convert AC voltage to DC voltage in the range of 3-12 volts, with 6 volts being a preferred voltage. The electrical adaptor may plug into the wall mount holder 902 at receptacle 912. In other implementations, batteries may be use instead of the electrical adaptor. In yet other implementations, the wall mount holder 902 may not contain any electronics and only function to hold the display coaster 102 upright.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed is:

1. A restaurant and bar consumer display, comprising:
a display;
a processor board with a controller and memory;
a power supply; and
a housing that holds the display and processor board, where the display is in signal communication with the controller and memory of the processor board when powered by the power supply.

2. The restaurant and bar consumer display of claim 1, further comprising a sensor coupled to the controller.

3. The restaurant and bar consumer display of claim 2, where the sensor is motion sensor.

4. The restaurant and bar consumer display of claim 3, where the motion sensor is a tilt sensor that senses tilt in at least one axis.

5. The restaurant and bar consumer display of claim 3, where the housing is at least a two piece case that encloses the processor board.

6. The restaurant and bar consumer display of claim 5, where the housing is sealed against moisture.

7. The restaurant and bar consumer display of claim 6, where the housing is a drink coaster.

8. The restaurant and bar consumer display of claim 6, where the housing is a table placard.

9. The restaurant and bar consumer display of claim 6, where the housing is a polypropylene housing.

10. The restaurant and bar consumer display of claim 2, where the sensor is a digital imaging device.

11. The restaurant and bar consumer display of claim 1, where the display is an OLED display.

12. The restaurant and bar consumer display of claim 1, where the display is a touch screen.

13. The restaurant and bar consumer display of claim 1, including a wireless receiver coupled to the controller.

14. The restaurant and bar consumer display of claim 13, where the wireless receiver is a Bluetooth receiver.

15. The restaurant and bar consumer display of claim 13, where the wireless receiver is a wireless internet receiver.

16. The restaurant and bar consumer display of claim 1, including a transceiver coupled to the controller.

17. The restaurant and bar consumer display of claim 1, where the memory stores statistical information associated with a customer.

18. The restaurant and bar consumer display of claim 1, including a radio frequency identification (RFID) tag within the housing.

19. The restaurant and bar consumer display of claim 1, where digital content that is displayable in the display is responsive the RFID tag, where the RFID tag triggers the digital content.

20. The restaurant and bar consumer display of claim 1,
